(19) United States
(12) Patent Application Publication
(10) Pub. No.: US 2018/0001836 A1
(43) Pub. Date: Jan. 4, 2018

(54) INNER REAR-VIEW MIRROR SYSTEM FOR AUTOMOBILE WITH CAMERAS

(71) Applicant: Lei Pan, Shenzhen (CN)

(72) Inventor: Lei Pan, Shenzhen (CN)

(21) Appl. No.: 15/541,697

(22) PCT Filed: Jul. 6, 2015
(86) PCT No.: PCT/CN2015/083414

§ 371 Date: Jul. 12, 2017

(30) Foreign Application Priority Data
Jan. 5, 2015 (CN) 201520006495.9

(51) Int. Cl. B60R 11/04; H04N 7/18; B60R 1/00; H04N 5/225

(52) U.S. Cl. CPC B60R 11/04; H04N 5/2251; H04N 7/181; B60R 1/00; B60R 2300/105; B60R 2300/301; B60R 2300/8026

(57) ABSTRACT

Disclosed is an inner rear-view mirror system for an automobile with cameras, which comprises a rotatable single-axle shooting device (1) of a license plate frame and a rotatable shooting device (2) with a triangular connecting rod on the top. The rotatable single-axle shooting device (1) of the license plate frame comprises a first camera (10). The rotatable single-axle shooting device (1) of the license plate frame is used for rotating about an edge of the license plate frame (4) as a rotation axis, so that the first camera (10) is driven to turn and protrude out of the spatial position of the license plate frame (4). The rotatable shooting device (2) with a triangular connecting rod on the top comprises four second cameras (20). The rotatable shooting device (2) with a triangular connecting rod on the top is used for driving the four second cameras (20) to horizontally move simultaneously along the front and back direction or the left and right direction of the vehicle. A rotatable single-axle shooting device (3) on the top comprises a third camera (30) and a rotary handle (31). The rotatable single-axle shooting device (3) of the roof is used for driving the third camera (30) to move along a circular path with the length of the rotary handle (31) as the radius. The above-mentioned inner rear-view mirror system for an automobile with cameras solves the technical problems, such as the blind angle present during shooting with a traditional inner rear-view mirror system for an automobile with cameras.

### TECHNICAL FIELD

The present application relates to the field of vehicle parts, and particularly to a vehicle interior rearview mirror system with cameras.

### BACKGROUND ART

In the prior art, many vehicles are installed with a device having a function of displaying vehicle reversing images. Such device generally has the following configurations: a reversing camera is usually installed at the rear of the vehicle, and a vehicle interior rearview mirror with a display hidden therein or other displays such as a DVD integrated machine are installed at the position of the center console in front of a driver (so that when reversing, the driver can clearly see the scene behind the vehicle directly through the display to know relevant conditions and environment during reversing, without looking back).

In general, when it is shifted to a reverse gear by a driver, a signal of a reversing lamp is transmitted to the reversing camera and the display, and then the reversing camera and the display are started at the same time. The reversing camera can transmit the taken images behind the vehicle to the display in real time, so that the display can synchronously display the scene behind the vehicle in real time for the driver watching the conditions behind the vehicle.

However, the above described prior art also has technical defects and problems in the following several aspects: 1. For the device (i.e., rearview imaging device) having the function of displaying vehicle reversing images in the prior art, since the reversing camera is fixedly installed at the rear of the vehicle (i.e. generally right behind the vehicle) and a rotation angle of the reversing camera is also fixed, shooting blind angles easily occur in the rearview imaging device in the prior art. Moreover, the images with shooting blind angles often lead to misjudgment of the driver, thereby causing occurrence of car accidents. 2. In the specific structure, the installation mode and the installation structure of the traditional rearview imaging device are not flexible enough. As the traditional rearview imaging device is generally installed below a taillight, such that the reversing camera can hardly shoot the scenes at two sides of the vehicle (two sides of the vehicle body) and in the vicinity of the rear tires. 3. The traditional reversing camera can only shoot some areas of the vehicle, rather than provide a panoramic view of the situation around the vehicle.

In conclusion, how to overcome the above technical defects in the prior art is a problem to be solved urgently by a person skilled in the art.

### DISCLOSURE OF THE INVENTION

An object of the present application is to provide a vehicle interior rearview mirror system with cameras, so as to solve the technical problems of a vehicle interior rearview mirror system with cameras in the prior art, such as long time required for adjusting the built-in camera to an optimal angle.

In an embodiment of the present application, a vehicle interior rearview mirror system with cameras is provided, which includes a license plate frame single-axis rotatable shooting device (i.e. a shooting device capable of rotating around a single axis on a license plate frame) provided on a license plate frame at the rear of a vehicle, and a vehicle roof triangular connection rod rotatable shooting device (i.e. a shooting device capable of rotating through a triangular connection rod on a vehicle roof) or a vehicle roof single-axis rotatable shooting device (i.e. a shooting device capable of rotating around a single axis on a vehicle roof) provided on the top of the vehicle. Abovementioned devices are configured for driving the cameras to protrude out from the license plate frame or a roof rack to a position at a certain distance from the vehicle for shooting.

Specifically, the license plate frame single-axis rotatable shooting device includes a first camera. The license plate frame single-axis rotatable shooting device is configured for rotating about a border of the license plate frame with the border as a rotation shaft, after the vehicle starts to reverse, so as to drive the first camera to turn and protrude out from the spatial position of the license plate frame.

The vehicle roof triangular connection rod rotatable shooting device includes four second cameras facing forward, backward, leftward and rightward, respectively. The vehicle roof triangular connection rod rotatable shooting device is configured for driving the four second cameras to horizontally move simultaneously in the front-rear direction or the left-right direction of the vehicle, after the vehicle starts to reverse.

The vehicle roof single-axis rotatable shooting device includes a third camera and a rotary handle; and the third camera is provided at one end of the rotary handle. The vehicle roof single-axis rotatable shooting device is configured for driving the rotary handle to rotate and driving the third camera to move along a circular path, with the length of the rotary handle as the radius, after the vehicle starts to reverse. The circular path of the rotary handle covers the front side, the rear side, the left side and the right side of the vehicle.

The first camera of the license plate frame single-axis rotatable shooting device, the second cameras of the vehicle roof triangular connection rod rotatable shooting device and the third camera of the vehicle roof single-axis rotatable shooting device are each in communication with a display on a center console of the vehicle.

Optionally, the license plate frame single-axis rotatable shooting device further includes a first natural magnet and an electronic magnet that are fixedly connected to the top border of the license plate frame.

The license plate frame single-axis rotatable shooting device further includes a rotary handle which rotates in a plane where the top border of the license plate frame is located, and the rotary handle rotates about the left border of the license plate frame. One end of the rotary handle is rotationally connected with the top border of the license plate frame and is sequentially connected with a gear box and a motor, and the other end of the rotary handle is provided with the first camera. An inner layer of the rotary handle is further provided with a ranging radar, a second natural magnet and a third natural magnet. The motor is rotationally connected with the gear box, and the gear box is in key connection with the rotary handle.

After the rotary handle rotates with respect to the license plate frame to be in a closed state, the first natural magnet at the top border of the license plate frame and the second natural magnet of the rotary handle are opposite to each other in position, and opposite in magnetic polarity. After the rotary handle rotates with respect to the license plate frame to be in an opened state, the electronic magnet at the top border of the license plate frame and the third natural magnet of the rotary handle are opposite to each other in position, and have the same magnetic polarity.

Optionally, the license plate frame single-axis rotatable shooting device further includes a first natural magnet and an electronic magnet that are fixedly connected to the bottom border of the license plate frame.

The license plate frame single-axis rotatable shooting device further includes a rotary handle which rotates in a plane where the bottom border of the license plate frame is located, and the rotary handle rotates about the left border of the license plate frame. One end of the rotary handle is rotationally connected with the bottom border of the license plate frame and is sequentially connected with a gear box and a motor, and the other end of the rotary handle is provided with the first camera. An inner layer of the rotary handle is further provided with a ranging radar, a second natural magnet and a third natural magnet. The motor is rotationally connected with the gear box, and the gear box is in key connection with the rotary handle.

After the rotary handle rotates with respect to the license plate frame to be in a closed state, the first natural magnet at the bottom border of the license plate frame and the second natural magnet of the rotary handle are opposite to each other in position, and opposite in magnetic polarity. After the rotary handle rotates with respect to the license plate frame to be in an opened state, the electronic magnet at the bottom border of the license plate frame and the third natural magnet of the rotary handle are opposite to each other in position, and have the same magnetic polarity.

Optionally, the license plate frame single-axis rotatable shooting device further includes a first natural magnet and a second natural magnet that are fixedly connected to the bottom border of the license plate frame.

The license plate frame single-axis rotatable shooting device further includes a rotary support in shape same as that of the license plate frame. The top edge of the rotary support is rotationally connected with the top border of the license plate frame, and the top edge of the rotary support rotates about the top border of the license plate frame. The top edge of the rotary support is provided thereon with a rotary shaft. The rotary shaft is sequentially connected with a gear box and a motor. Moreover, the motor is rotationally connected with the gear box, and the gear box is in key connection with the rotary shaft on the rotary support. The bottom edge of the rotary support is provided therein with a third natural magnet, an electronic magnet and the first camera.

After the rotary support rotates with respect to the license plate frame to be in a closed state, the first natural magnet at the bottom border of the license plate frame and the third natural magnet of the rotary support are opposite to each other in position, and opposite in magnetic polarity. After the rotary support rotates with respect to the license plate frame to be in an opened state, the second natural magnet at the bottom border of the license plate frame and the electronic magnet of the rotary support are opposite to each other in position, and have the same magnetic polarity.

Optionally, the license plate frame single-axis rotatable shooting device further includes a first natural magnet and a second natural magnet that are fixedly connected to the top border of the license plate frame.

The license plate frame single-axis rotatable shooting device further includes a rotary support in shape same as that of the license plate frame. The bottom edge of the rotary support is rotationally connected with the bottom border of the license plate frame, and the bottom edge of the rotary support rotates about the bottom border of the license plate frame. The top edge of the rotary support is provided thereon with a rotary shaft. The rotary shaft is sequentially connected with a gear box and a motor. Moreover, the motor is rotationally connected with the gear box, and the gear box is in key connection with the rotary shaft on the rotary support. The bottom edge of the rotary support is provided therein with a third natural magnet, an electronic magnet and the first camera.

After the rotary support rotates with respect to the license plate frame to be in a closed state, the first natural magnet at the top border of the license plate frame and the third natural magnet of the rotary support are opposite to each other in position, and opposite in magnetic polarity. After the rotary support rotates with respect to the license plate frame in an opened state, the second natural magnet at the top border of the license plate frame and the electronic magnet of the rotary support are opposite to each other in position, and have the same magnetic polarity.

Optionally, the first camera is fixedly connected to the bottom of the rotary handle. A lens of the first camera is arranged to face downward.

Optionally, the first camera is fixedly connected to the bottom of the rotary support. The lens of the first camera is arranged to face downward.

Optionally, the vehicle roof triangular connection rod rotatable shooting device further includes a fixing bracket and two shaft sleeves provided at the two ends of the fixing bracket in the front-rear direction of the vehicle.

The vehicle roof triangular connection rod rotatable shooting device further includes a screw rod outside which the two shaft sleeves are sleeved in the front-rear direction of the vehicle, a shooting rod hinged to one of the shaft sleeves, and a connection rod arranged between the shooting rod and the screw rod. The screw rod, the shooting rod and the connection rod define a triangular shape; one end of the connection rod is hinged to the shooting rod, and the screw rod and the other end of the connection rod form a screw motion pair. The end of the shooting rod, away from the hinged portion, is further fixedly connected with a housing. The housing is provided with the second cameras in four directions facing forward, backward, leftward and rightward, respectively, and the housing is also provided therein with a ranging radar. One end of the screw rod is further sequentially connected with a gear box and a motor; and the motor is rotationally connected with the gear box, and the gear box is in key connection with the screw rod.

Optionally, the vehicle roof triangular connection rod rotatable shooting device further includes a fixing bracket and two shaft sleeves provided at two ends of the fixing bracket in the left-right direction of the vehicle.

The vehicle roof triangular connection rod rotatable shooting device further includes a screw rod outside which the two shaft sleeves are sleeved in the left-right direction of the vehicle, a shooting rod hinged to one of the shaft sleeves, and a connection rod arranged between the shooting rod and the screw rod. The screw rod, the shooting rod and the connection rod define a triangular shape; one end of the connection rod is hinged to the shooting rod, and the other end of the connection rod and the screw rod form a screw motion pair. The end of the shooting rod, away from the hinged portion, is further fixedly connected with a housing. The housing is provided with the second cameras in four directions facing forward, backward, leftward and rightward, respectively, and the housing is also provided therein with a ranging radar. One end of the screw rod is further sequentially connected with a gear box and a motor; and the motor is rotationally connected with the gear box, and the gear box is in key connection with the screw rod.

Optionally, the vehicle roof single-axis rotatable shooting device further includes a motor support and a magnet box that are arranged at the two ends respectively. The motor support is configured for being fixedly connected with the motor and the gear box, the motor is rotationally connected with the gear box, and the gear box is in key connection with the rotary handle. The magnet box is provided therein with a third natural magnet and an electronic magnet.

The vehicle roof single-axis rotatable shooting device further includes a rotary handle which pivots about the motor support. One end of the rotary handle is sequentially connected with the gear box and the motor, and the other end of the rotary handle is further provided with a third camera, a ranging radar, a first natural magnet and a second natural magnet.

After the rotary handle rotates to close the magnet box, the third natural magnet in the magnet box and the first natural magnet of the rotary handle are opposite to each other in position, and opposite in magnetic polarity. After the rotary handle rotates to open the magnet box, the electronic magnet in the magnet box and the second natural magnet of the rotary handle are opposite to each other in position, and have the same magnetic polarity.

With regard to the vehicle interior rearview mirror system with built-in cameras provided the present application, it can be known by analyzing the abovementioned structures: the license plate frame single-axis rotatable shooting device has a rotary telescopic structure and function, and can drive the first camera to adjust a shooting position (achieved by the rotation angle) and a shooting angle for the scenes behind the vehicle, which enables clear shooting of the scenes at two sides of the vehicle (the two sides of the vehicle body) and in the vicinity of the tires as obtained by the reversing camera; the vehicle roof triangular connection rod rotatable shooting device mainly has a structure of four second cameras, and can drive the four second cameras to perform front-back translation or left-right translation (achieving reciprocating movement), so as to achieve the object of telescopic movement, in this way, it can help the four second cameras shoot the scenes more clearly in front of the vehicle, behind the vehicle, on the left side of the vehicle and on the right side of the vehicle, respectively; in addition, the vehicle roof single-axis rotatable shooting device arranged on the top of the vehicle can drive the third camera to rotate and move along the circular path, with the length of the rotary handle as a radius, thereby achieving the object of rotational and movable shooting, and further, as the circular path of the rotary handle covers the front side, the rear side, the left side and the right side of the vehicle, each of the scenes in front of the vehicle, behind the vehicle, on the left side of the vehicle and on the right side of the vehicle can be clearly shot by the third camera. Furthermore, the first camera, the second cameras and the third camera are each in communication with the display on the center console. Therefore, panoramic shots of the rear bottom of the vehicle and some of the areas surrounding the vehicle, namely in front of the vehicle, behind the vehicle, on the left side of the vehicle and on the right side of the vehicle, can be accomplished by a combination of the first camera and the second cameras or a combination of the first camera and the third camera, and then transmitted to the display, such that the driver can obtain the panoramic shots displaying situation around the vehicle.

In addition, it should be noted that the abovementioned three device structures can be adapted to different vehicles for use. The vehicle interior rearview mirror system with cameras provided in the embodiments of the present application may have various installation modes and installation structures, which avoids the installation mode of the traditional rearview imaging devices that are generally installed below the taillight, and also overcomes the technical defects that the shooting visual angle is constrained and the images shot have blind angles.

### BRIEF DESCRIPTION OF DRAWINGS

In order to describe the embodiments of the present application or the technical solutions in the prior art more clearly, brief description is made below on the drawings required to be used in the description of the embodiments or the prior art. Obviously, the drawings in the following description are some embodiments of the present application, and for a person ordinarily skilled in the art, other drawings may also be obtained according to theses drawings, without using inventive efforts.

FIG. 1 is a schematic diagram showing a license plate frame single-axis rotatable shooting device, provided in Embodiment 2 of the present application, changed from an exploded structure to an assembled structure;

FIG. 2 is a schematic exploded structural diagram of a part of the license plate frame single-axis rotatable shooting device provided in Embodiment 2 of the present application;

FIG. 3 is a schematic structural diagram of the license plate frame single-axis rotatable shooting device provided in Embodiment 2 of the present application;

FIG. 4 is a schematic structure diagram showing the license plate frame single-axis rotatable shooting device, provided in Embodiment 2 of the present application, in a closed state;

FIG. 5 is a schematic structure diagram showing the license plate frame single-axis rotatable shooting device, provided in Embodiment 2 of the present application, in an opened state;

FIG. 6 is a schematic diagram of the principle of the license plate frame single-axis rotatable shooting device, provided in Embodiment 2 of the present application, in a shooting state;

FIG. 7 is a schematic structural diagram showing a license plate frame single-axis rotatable shooting device, provided in Embodiment 3 of the present application, changed from an exploded structure to an assembled structure;

FIG. 8 is a schematic structural diagram of the license plate frame single-axis rotatable shooting device provided in Embodiment 3 of the present application;

FIG. 9 is a schematic structural diagram of the license plate frame single-axis rotatable shooting device, provided in Embodiment 3 of the present application, in a closed state;

FIG. 10 is a schematic structural diagram of the license plate frame single-axis rotatable shooting device, provided in Embodiment 3 of the present application, in an opened state;

FIG. 11 is a schematic structural diagram showing a license plate frame single-axis rotatable shooting device, provided in Embodiment 4 of the present application, changed from an exploded structure to an assembled structure;

FIG. 12 is a schematic structural diagram of the license plate frame single-axis rotatable shooting device, provided in Embodiment 4 of the present application, in a closed state;

FIG. 13 is a schematic structural diagram of the license plate frame single-axis rotatable shooting device, provided in Embodiment 4 of the present application, in an opened state;

FIG. 14 is a schematic structural diagram of the license plate frame single-axis rotatable shooting device, provided in Embodiment 4 of the present application, in a shooting state;

FIG. 15 is a schematic structural diagram showing a license plate frame single-axis rotatable shooting device, provided in Embodiment 5 of the present application, changed from an exploded structure to an assembled structure;

FIG. 16 is a schematic structural diagram of the license plate frame single-axis rotatable shooting device, provided in Embodiment 5 of the present application, in an opened state;

FIG. 17 is a schematic structural diagram of the license plate frame single-axis rotatable shooting device, provided in Embodiment 5 of the present application, in a shooting state;

FIG. 18 is a schematic structural diagram showing a vehicle roof triangular connection rod rotatable shooting device, provided in Embodiment 6 of the present application, changed from an exploded structure to an assembled structure;

FIG. 19 is a schematic structural diagram of the vehicle roof triangular connection rod rotatable shooting device provided in Embodiment 6 of the present application;

FIG. 20 is a schematic structural diagram showing a vehicle roof triangular connection rod rotatable shooting device, provided in Embodiment 7 of the present application, changed from an exploded structure to an assembled structure;

FIG. 21 is a schematic structural diagram of the vehicle roof triangular connection rod rotatable shooting device provided in Embodiment 7 of the present application;

FIG. 22 is a schematic structural diagram showing a vehicle roof single-axis rotatable shooting device, provided in Embodiment 8 of the present application, changed from an exploded structure to an assembled structure;

FIG. 23 is a schematic structural diagram of the vehicle roof single-axis rotatable shooting device, provided in Embodiment 8 of the present application, in an opened state; and

FIG. 24 is a schematic structural diagram of the vehicle roof single-axis rotatable shooting device, provided in Embodiment 8 of the present application, in a shooting state.

### DETAILED DESCRIPTION OF EMBODIMENTS

The technical solutions of the present application will be described clearly and completely below with reference to the accompanying drawings.

### Embodiment 1

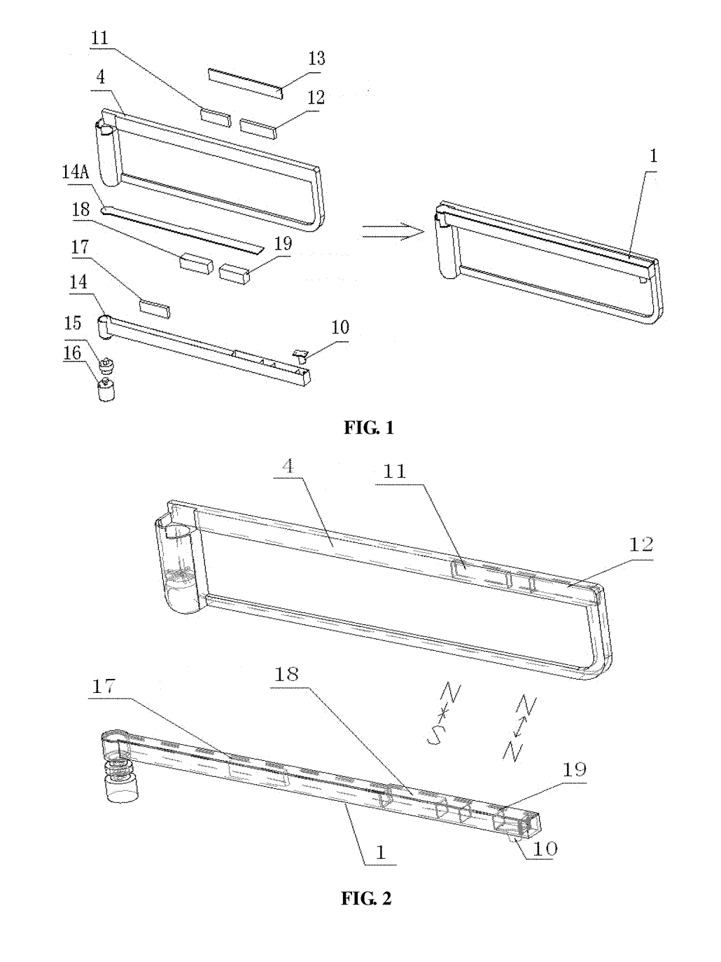

As shown in FIG. 1, a vehicle interior rearview mirror system with cameras provided in the present embodiment includes a license plate frame single-axis rotatable shooting device 1 provided on a license plate frame at the rear of a vehicle, and a vehicle roof triangular connection rod rotatable shooting device 2 provided on the top of the vehicle or a vehicle roof single-axis rotatable shooting device 3 provided on the top of the vehicle. Abovementioned devices are configured for driving the cameras to protrude out from the license plate frame or a roof rack to a position at a certain distance from the vehicle for shooting.

Specifically, as shown in FIG. 1, the license plate frame single-axis rotatable shooting device 1 includes a first camera 10. The license plate frame single-axis rotatable shooting device is configured for rotating about a border of the license plate frame 4 with the border as a rotation shaft, after the vehicle starts to reverse, so as to drive the first camera 10 to turn and protrude out from the spatial position of the license plate frame 4.

It should be noted that, the abovementioned border of the license plate frame may be a top border, a bottom border, a left border or a right border of the license plate frame. Therefore, the abovementioned license plate frame single-axis rotatable shooting device can specifically have four structural forms, and as to the details, reference can be made to the following four structures of the license plate frame single-axis rotatable shooting device. In addition, when the license plate frame single-axis rotatable shooting device rotates about one border of the license plate frame with the border as the rotation shaft, after the vehicle starts to reverse, so as to drive the first camera to turn and protrude out from the spatial position of the license plate frame, the first camera immediately implements the change of turning over to protrude out from the spatial position of the license plate frame. In this way, the first camera will not be constrained in position by the license plate frame, and then can shoot the scene behind the vehicle, which also makes it convenient for the first camera to shoot the scenes below the vehicle and in the vicinity of the tires. On the contrary, after the vehicle stops reversing, the first camera can be driven to retract to the spatial position of the license plate frame, and as to the specific structure, reference can be made to the following specific technical contents.

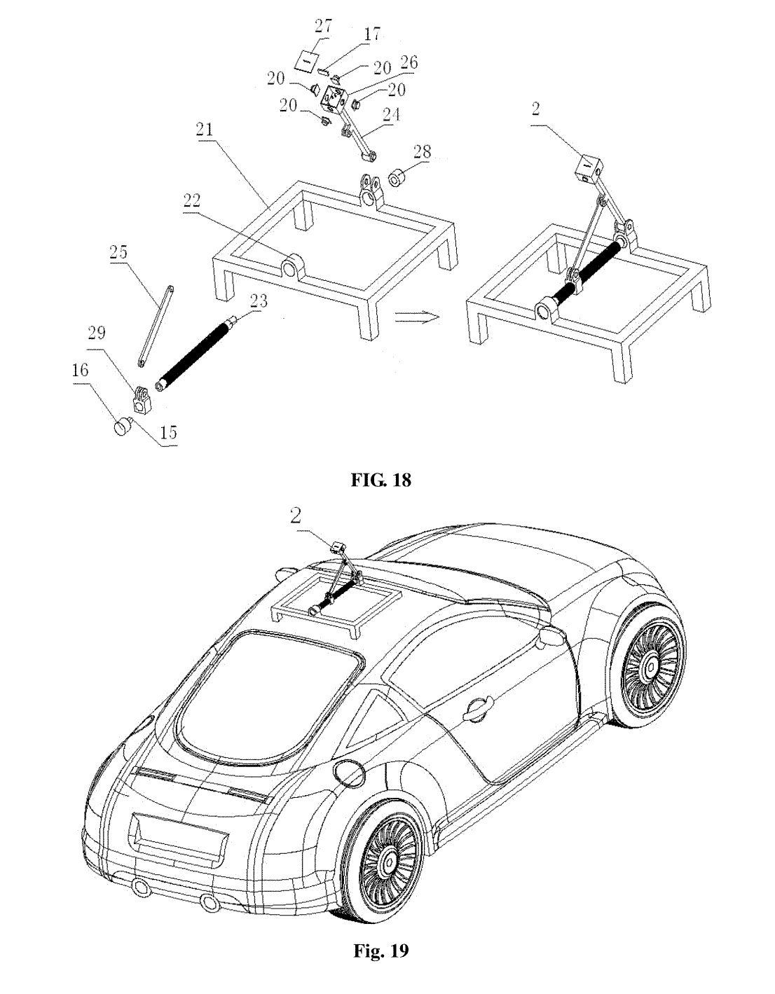

As shown in FIG. 18, the vehicle roof triangular connection rod rotatable shooting device 2 includes four second cameras 20 facing forward, backward, leftward and rightward, respectively. The vehicle roof triangular connection rod rotatable shooting device is configured for driving the four second cameras 20 to horizontally move simultaneously in the front-rear direction or the left-right direction of the vehicle, after the vehicle starts to reverse.

It should be noted that main structure of the vehicle roof triangular connection rod rotatable shooting device consists of the four second cameras facing four directions and other structures. The vehicle roof triangular connection rod rotatable shooting device can drive the four second cameras to perform a front-back translation or a left-right translation (achieving reciprocating movement), so as to achieve the object of telescopic movement. In this way, it can help the four second cameras shoot the scenes more clearly in front of the vehicle, behind the vehicle, on the left side of the vehicle and on the right side of the vehicle, respectively.

As shown in FIG. 22, the vehicle roof single-axis rotatable shooting device 3 includes a third camera 30 and a rotary handle 31; and the third camera is provided at one end of the rotary handle. The vehicle roof single-axis rotatable shooting device is configured for driving the rotary handle 31 to rotate and driving the third camera 30 to move along a circular path, with the length of the rotary handle as the radius, after the vehicle starts to reverse. The circular path of the rotary handle 31 covers the front side, the rear side, the left side and the right side of the vehicle.

It should be noted that main structure of the vehicle roof single-axis rotatable shooting device consists of one third camera and a rotary handle with a certain length, and other structures. The vehicle roof single-axis rotatable shooting device can be configured for driving the third camera to rotate and move along the circular path, with the length of the rotary handle as the radius, after the vehicle starts to reverse, thereby achieving the object of rotational and movable shooting. Further, as the circular path of the rotary handle covers the front side, the rear side, the left side and the right side of the vehicle, each of the scenes in front of the vehicle, behind the vehicle, on the left side of the vehicle and on the right side of the vehicle can be clearly shot by the third camera.

The first camera of the license plate frame single-axis rotatable shooting device, the second cameras of the vehicle roof triangular connection rod rotatable shooting device and the third camera of the vehicle roof single-axis rotatable shooting device are each in communication with a display on a center console of the vehicle. By means of the abovementioned communication, the images shot by the cameras can be transmitted in real time to the display for the driver's awareness and use.

It can be known by analyzing the abovementioned structures: the license plate frame single-axis rotatable shooting device has a rotary telescopic structure and function, and can drive the first camera to adjust a shooting position (achieved by the rotation angle) and a shooting angle for the scenes behind the vehicle, which enables clear shooting of the scenes at two sides of the vehicle (the two sides of the vehicle body) and in the vicinity of the tires as obtained by the reversing camera; the vehicle roof triangular connection rod rotatable shooting device mainly has a structure of four second cameras, and can drive the four second cameras to perform the front-back translation or the left-right translation (achieving the reciprocating movement), so as to achieve the object of telescopic movement, in this way, it can help the four second cameras shoot the scenes more clearly in front of the vehicle, behind the vehicle, on the left side of the vehicle and on the right side of the vehicle, respectively; in addition, the vehicle roof single-axis rotatable shooting device arranged on the top of the vehicle can drive the third camera to rotate and move along the circular path, with the length of the rotary handle as the radius, thereby achieving the object of rotational and movable shooting, and further, as the circular path of the rotary handle covers the front side, the rear side, the left side and the right side of the vehicle, each of the scenes in front of the vehicle, behind the vehicle, on the left side of the vehicle and on the right side of the vehicle can be clearly shot by the third camera. Furthermore, the first camera, the second cameras and the third camera are each in communication with the display on the center console. Therefore, panoramic shots of the rear bottom of the vehicle and some of the areas surrounding the vehicle, namely in front of the vehicle, behind the vehicle, on the left side of the vehicle and on the right side of the vehicle, can be accomplished by a combination of the first camera and the second cameras or a combination of the first camera and the third camera, and then transmitted to the display, such that the driver can obtain the panoramic shots displaying the situation around the vehicle.

In addition, it should be noted that the abovementioned three device structures can be adapted to different vehicles for use. The vehicle interior rearview mirror system with cameras provided in the embodiments of the present application can have various installation modes and installation structures, which avoids the installation mode of the traditional rearview imaging devices that are generally installed below the taillight, and also overcomes the technical defects that the shooting visual angle is constrained and the images shot have blind angles.

The specific structure, technical principle and technical effects of the vehicle interior rearview mirror system with cameras provided in Embodiment 1 of the present application will be described in detail below (as to the details, reference is made to the following several embodiments).

The license plate frame single-axis rotatable shooting device specifically has four structural forms on the basis of the basic structure provided in Embodiment 1. The four structural forms have four installation modes and connection modes, respectively, which are specifically a license plate frame side border upper rotation mode (i.e., a mode of rotation about one side border of the license plate frame and in a plane where a top border of the license plate frame is located, see Embodiment 2), a license plate frame side border lower rotation mode (i.e., a mode of rotation about one side border of the license plate frame and in a plane where a bottom border of the license plate frame is located, see Embodiment 3), a license plate frame top border rotation mode (i.e., a mode of rotation about a top border of the license plate frame, see Embodiment 4) and a license plate frame bottom border rotation mode(i.e., a mode of rotation about a bottom border of the license plate frame, see Embodiment 5). These four forms can be matched with different types of vehicles, which will be respectively described below.

### Embodiment 2

As to the basic structure provided in embodiment 1, comprised in the license plate frame single-axis rotatable shooting device provided in Embodiment 2, no further description is made herein.

Referring to the specific schematic structural diagram of a license plate frame single-axis rotatable shooting device, as shown in FIG. 1 (which is specifically a schematic diagram for illustrating an assembly of the license plate frame single-axis rotatable shooting device from an exploded structure to an assembled structure), the license plate frame single-axis rotatable shooting device 1 further includes a first natural magnet 11, an electronic magnet 12 and a side cover plate 13 that are fixedly connected to the top border of the license plate frame 4. The side cover plate 13 is configured for encapsulating both the first natural magnet 11 and the electronic magnet 12 in the top border of the license plate frame 4.

The license plate frame single-axis rotatable shooting device 1 further includes a rotary handle 14 which rotates in a plane where the top border of the license plate frame is located, and the rotary handle 14 rotates about the left border of the license plate frame 4. One end of the rotary handle 14 is rotationally connected with the top border of the license plate frame 4 and is sequentially connected with a gear box 15 (namely gearbox, increasing or reducing the speed of rotation through engagement with the gears with different sizes) and a motor 16, and the other end of the rotary handle 14 is provided with the first camera 10. An inner layer of the rotary handle 14 is further provided with a ranging radar 17, a second natural magnet 18 and a third natural magnet 19. An upper side of the rotary handle 14 is further provided with an upper cover plate 14A for sealing the ranging radar, the second natural magnet and the third natural magnet. Moreover, the motor 16 is rotationally connected with the gear box 15, and the gear box 15 is in key connection with the rotary handle 14.

After the rotary handle 14 rotates with respect to the license plate frame 4 to be in a closed state, the first natural magnet 11 at the top border of the license plate frame 4 and the second natural magnet 18 of the rotary handle 14 are opposite to each other in position, and opposite in magnetic polarity. After the rotary handle 14 rotates with respect to the license plate frame 4 to be in an opened state, the electronic magnet 12 at the top border of the license plate frame 4 and the third natural magnet 19 of the rotary handle 14 are opposite to each other in position, and have the same magnetic polarity.

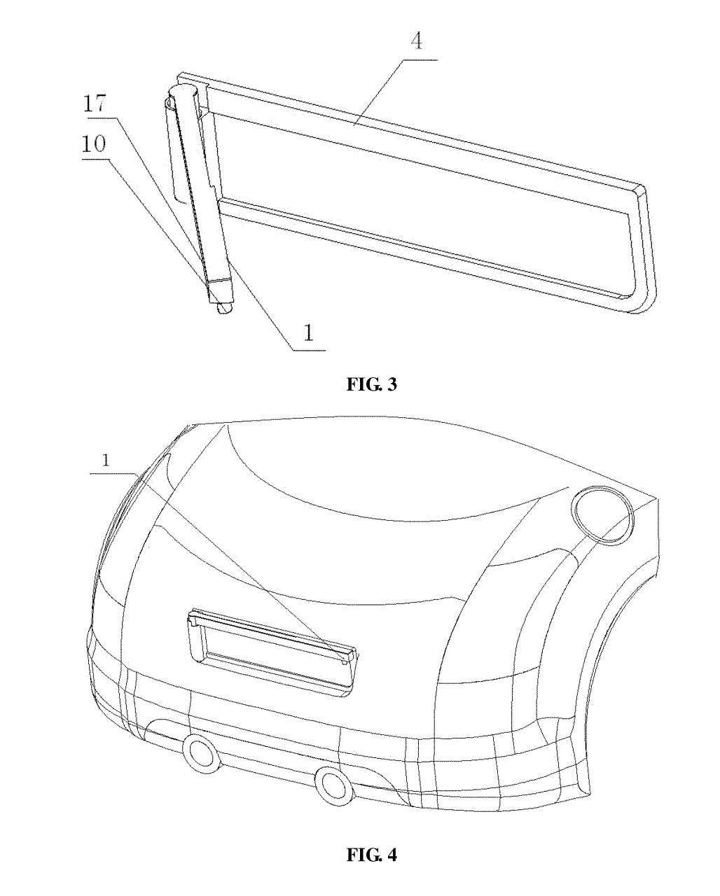

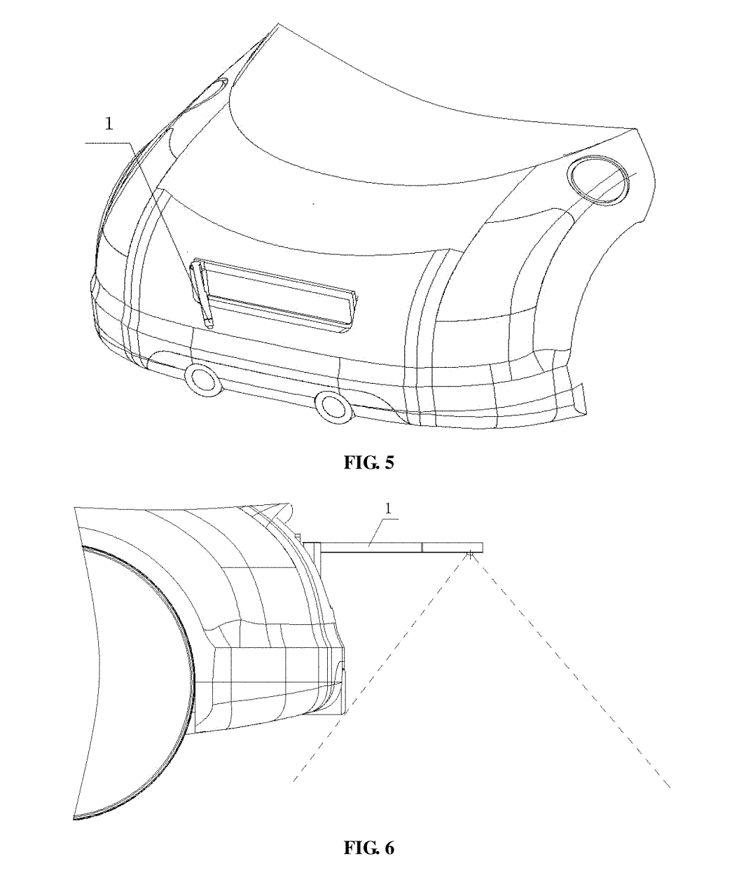

It should be noted that it can be known by analyzing the specific structure of above Embodiment 2: in fact, the license plate frame single-axis rotatable shooting device provided in embodiment 2 rotates about the left border of the license plate frame. The specific rotation structure is embodied as the rotary handle, one end of the rotary handle is connected with the motor through the gear box, and the motor may act as a source power to drive the gear box and the rotary handle to move, thereby achieving the object of driving the rotary handle to rotate. At the same time, the first camera at the other end of the rotary handle may be initially parallel to the top border of the license plate frame, and can protrude out from the spatial position of the license plate frame after rotation, so as to achieve the object that the first camera shoots the scenes at the rear bottom and two sides of the vehicle. The first camera may touch an object behind the vehicle after protruding out of the vehicle, therefore, the ranging radar is installed. The ranging radar (the installation position of the ranging radar is close to that of the first camera) may help the driver to identify the distance from the first camera to the object, so as to help the driver to drive backward. Specifically, for example, an alarm may be triggered when the ranging radar is too close to an object. In addition, as to the other specific structures (for example, the non-essential structures such as the side cover plate and the upper cover plate, and even some structures using common standard parts such as bolts, etc.) in the structure of the license plate frame single-axis rotatable shooting device in Embodiment 2 of the present application, no further description is made herein. As to the specific structures, reference can be made to FIG. 1, FIG. 2, FIG. 3, FIG. 4, FIG. 5 and FIG. 6.

### Embodiment 3

As to the basic structure provided in Embodiment 1, comprised in the license plate frame single-axis rotatable shooting device provided in Embodiment 3, no further description is made herein.

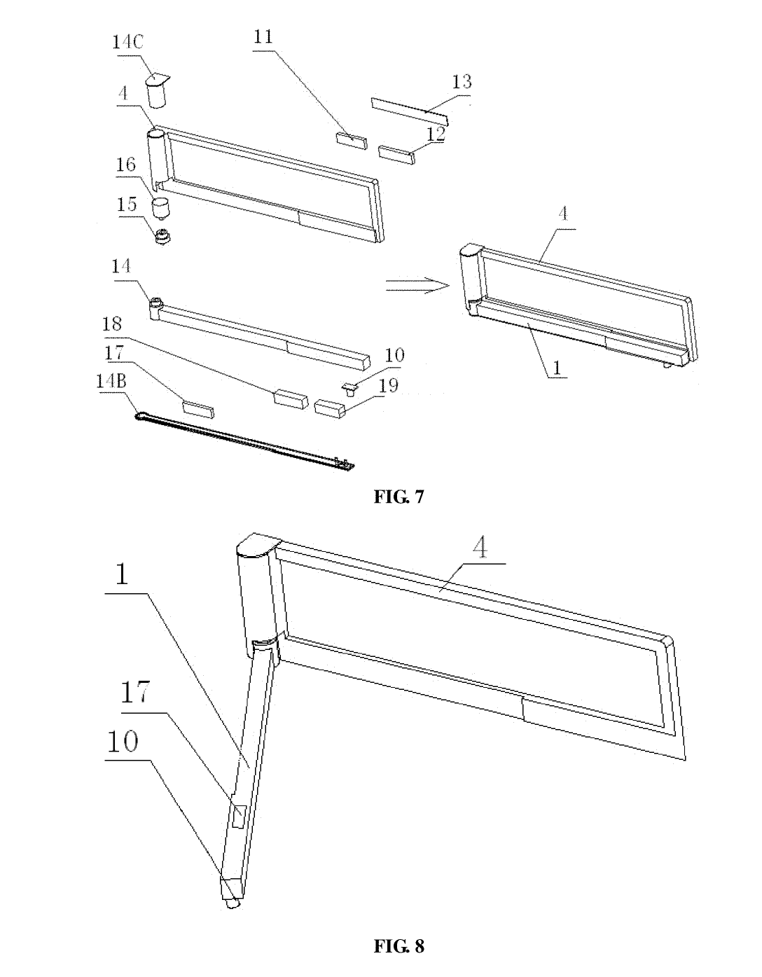

As shown in FIG. 7, the license plate frame single-axis rotatable shooting device 1 further includes a first natural magnet 11, an electronic magnet 12 and a side cover plate 13 that are fixedly connected to the bottom border of the license plate frame 4. The side cover plate 13 is configured for encapsulating both the first natural magnet 11 and the electronic magnet 12 in the bottom border of the license plate frame.

The license plate frame single-axis rotatable shooting device 1 further includes a rotary handle 14 which rotates in a plane where the bottom border of the license plate frame is located, and the rotary handle 14 rotates about the left border of the license plate frame 4. One end of the rotary handle 14 is rotationally connected with the bottom border of the license plate frame 4 and is sequentially connected with a gear box 15 and a motor 16, and the other end of the rotary handle 14 is provided with the first camera 10. An inner layer of the rotary handle 14 is further provided with a ranging radar 17, a second natural magnet 18 and a third natural magnet 19. The lower side of the rotary handle 14 is further provided with a lower cover plate 14B for sealing the ranging radar, the second natural magnet and the third natural magnet (the upper end of the left border of the license plate frame is further provided with an upper cover 14C for sealing). The motor 16 is rotationally connected with the gear box 15, and the gear box 15 is in key connection with the rotary handle 14.

After the rotary handle 14 rotates with respect to the license plate frame 4 to be in a closed state, the first natural magnet 11 at the bottom border of the license plate frame 4 and the second natural magnet 18 of the rotary handle 14 are opposite to each other in position, and opposite in magnetic polarity. After the rotary handle 14 rotates with respect to the license plate frame 4 to be in an opened state, the electronic magnet 12 at the bottom border of the license plate frame 4 and the third natural magnet 19 of the rotary handle 14 are opposite to each other in position, and have the same magnetic polarity.

It should be noted that it can be known by analyzing the specific structure of above Embodiment 3 (similar to the specific structure of Embodiment 2, specifically, the only differences lie in the installation position of the rotary handle and partial structures): in fact, the license plate frame single-axis rotatable shooting device provided in Embodiment 3 also rotates about the left border of the license plate frame (alternatively, it may also be designed to rotate about the right border). The specific rotation structure is embodied as the rotary handle, one end of the rotary handle is connected with a motor through a gear box, and the motor can act as a source power to drive the gear box and the rotary handle to move, thereby achieving the object of driving the rotary handle to rotate. At the same time, the first camera at the other end of the rotary handle can be initially parallel to the bottom border of the license plate frame, and can protrude out from the spatial position of the license plate frame after rotation, so as to achieve the object that the first camera shoots the scenes at the rear bottom and two sides of the vehicle. The first camera may touch an object behind the vehicle after protruding out of the vehicle, therefore, the ranging radar is installed. The ranging radar (the installation position of the ranging radar is close to that of the first camera) may help the driver to identify the distance from the first camera to the object, so as to help the driver to drive backward. Specifically, for example, an alarm may be triggered when the ranging radar is too close to an object. In addition, as to the other specific structures (for example, the non-essential structures such as the upper cover and the lower cover plate, and even some structures using common standard parts such as bolts, etc.) in the structure of the license plate frame single-axis rotatable shooting device in Embodiment 3 of the present application, no further description is made herein.

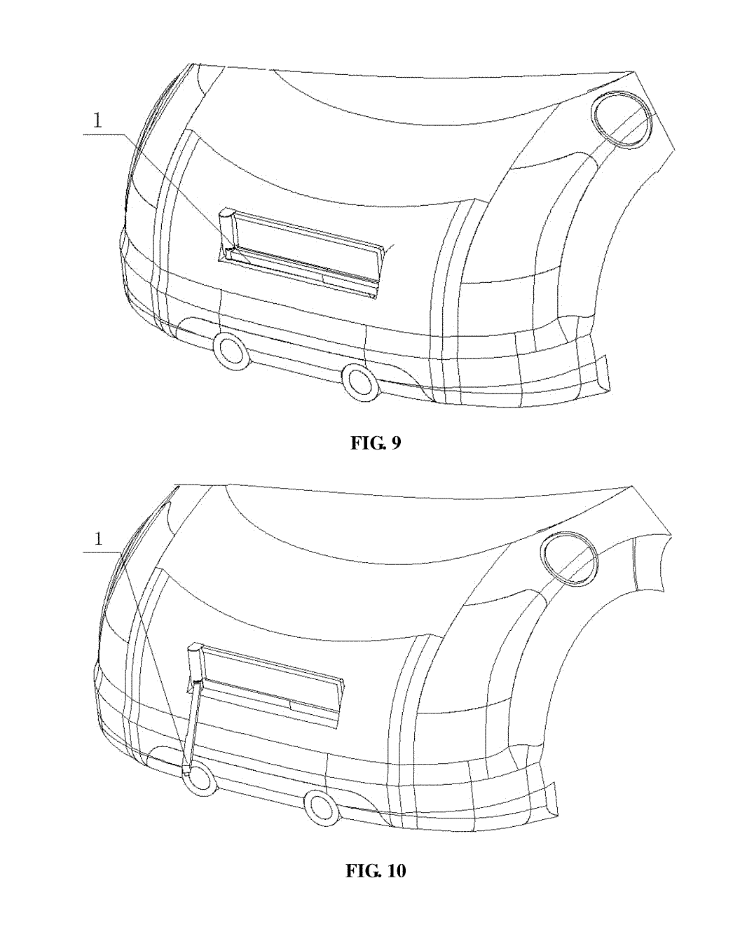

In conclusion, the license plate frame side border upper rotation mode and the license plate frame side border lower rotation mode have similar principles, except one being upper rotation, while the other being lower rotation, however, for both modes, the camera is driven to protrude out and retract by the gear box and the motor. FIG. 1, FIG. 2, FIG. 3, FIG. 4, FIG. 5 and FIG. 6 illustrate the license plate frame side border upper rotation mode and structure, and FIG. 7, FIG. 8, FIG. 9 and FIG. 10 illustrate the structural form of license plate frame side border lower rotation mode. The two modes can realize self-locking due to the arrangement of four magnets. In a closed state, between the first natural magnet and the second natural magnet, an S pole is versus to an N pole, or an N pole is versus to an S pole, which causes a strong attractive force therebetween. Also, between the electronic magnet and the third natural magnet, an S pole is versus to an N pole, or an N pole is versus to an S pole, in such case, the attractive force will make the rotating camera fixed. When the camera is in a working state, the attractive force between the third natural magnet and the electronic magnet 12 will change into a repulsive force. Moreover, the attractive force will also be smaller than the repulsive force. Due to driving by the motor, the third natural magnet and the electronic magnet will be separated.

### Embodiment 4

As to the basic structure provided in Embodiment 1, comprised in the license plate frame single-axis rotatable shooting device provided in Embodiment 4, no further description is made herein.

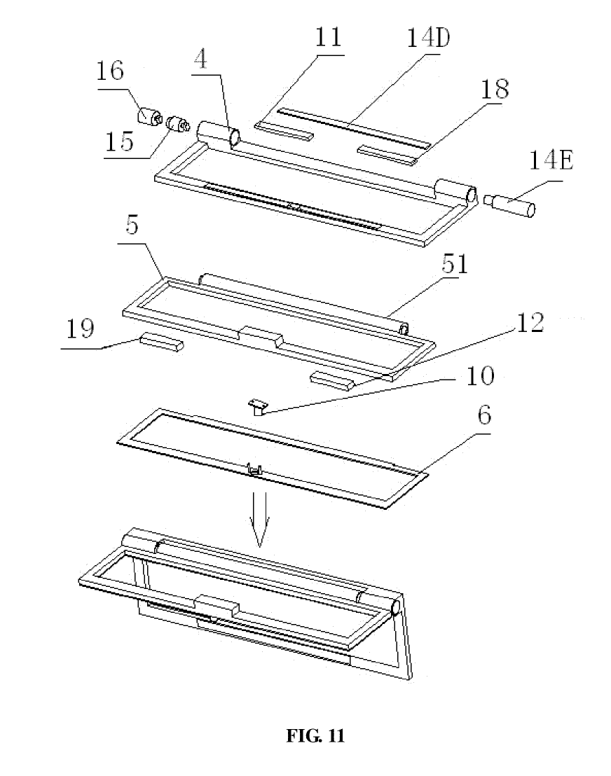

As shown in FIG. 11, the license plate frame single-axis rotatable shooting device 1 further includes a first natural magnet 11, a second natural magnet 18 and a small cover plate 14D that are fixedly connected to the bottom border of the license plate frame 4. The small cover plate 14D is configured for encapsulating both the first natural magnet 11 and the second natural magnet 18 in the bottom border of the license plate frame 4.

The license plate frame single-axis rotatable shooting device 1 further includes a large cover plate 6 and a rotary support 5 in shape same as that of the license plate frame 4. The top edge of the rotary support 5 is rotationally connected with the top border of the license plate frame 4, and the top edge of the rotary support 5 rotates about the top border of the license plate frame 4. The top edge of the rotary support 5 is provided thereon with a rotary shaft 51. The rotary shaft 51 is sequentially connected with a gear box 15 and a motor 16. Moreover, the motor 16 is rotationally connected with the gear box 15, and the gear box 15 is in key connection with the rotary shaft 51 on the rotary support 5. The bottom edge of the rotary support 5 is provided therein with a third natural magnet 19, an electronic magnet 12 and the first camera 10. The large cover plate 6 is configured for sealing the third natural magnet 19, the electronic magnet 12 and the first camera 10 in the rotary support 5.

After the rotary support 5 rotates with respect to the license plate frame 4 to be in a closed state, the first natural magnet 11 at the bottom border of the license plate frame 4 and the third natural magnet 19 of the rotary support 5 are opposite to each other in position, and opposite in magnetic polarity. After the rotary support 5 rotates with respect to the license plate frame 4 to be in an opened state, the second natural magnet 18 at the bottom border of the license plate frame 4 and the electronic magnet 12 of the rotary support 5 are opposite to each other in position, and have the same magnetic polarity.

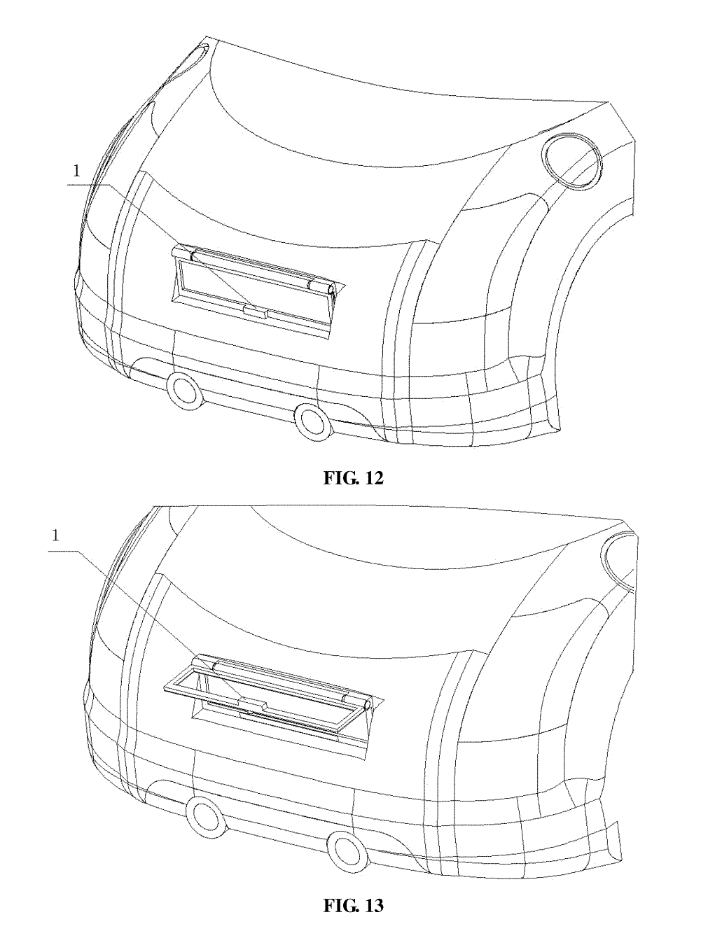

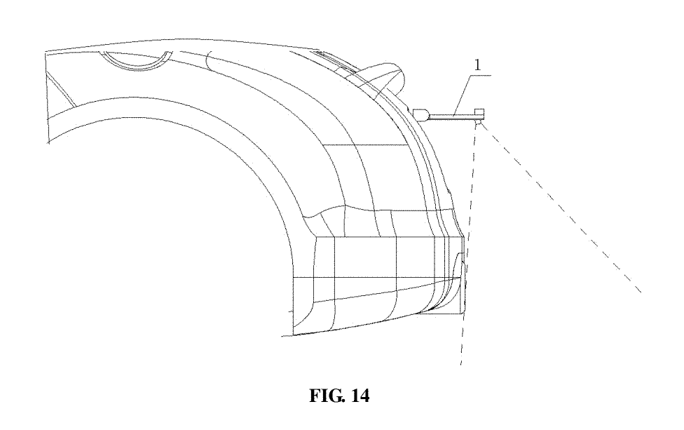

It should be noted that it can be known by analyzing the specific structure of above Embodiment 4: First, as to the core structure, and the rotary support are rotatable relative to the license plate frame, wherein the top edge of the rotary support is provided thereon with a rotary shaft as a rotation shaft, actually, the rotary support likewise rotates about one border of the license plate frame (i.e., rotating about the top border of the license plate frame). The rotation angle of the rotary shaft is changed through driving by means of the motor and the gear box. After the motor finally drives the rotary shaft to rotate by a certain angle, the first camera in the bottom edge of the rotary support can realize rotation-caused protrusion and retraction, independent of the original spatial position of the license plate frame, enabling the first camera to shoot the scenes at the rear bottom of the vehicle. At the same time, the magnetic devices on the abovementioned rotary support and the license plate frame can help to realize the separation and attachment through rotation. As to the non-core structures (e.g., the small cover plate 14D, the large cover plate 6, a reel 14E), no further description is made herein. As to the corresponding mode of rotation about the top border of the license plate frame, reference can mainly be made to FIG. 11, FIG. 12, FIG. 13 and FIG. 14.

### Embodiment 5

As to the basic structure provided in Embodiment 1, comprised in the license plate frame single-axis rotatable shooting device provided in Embodiment 5, no further description is made herein.

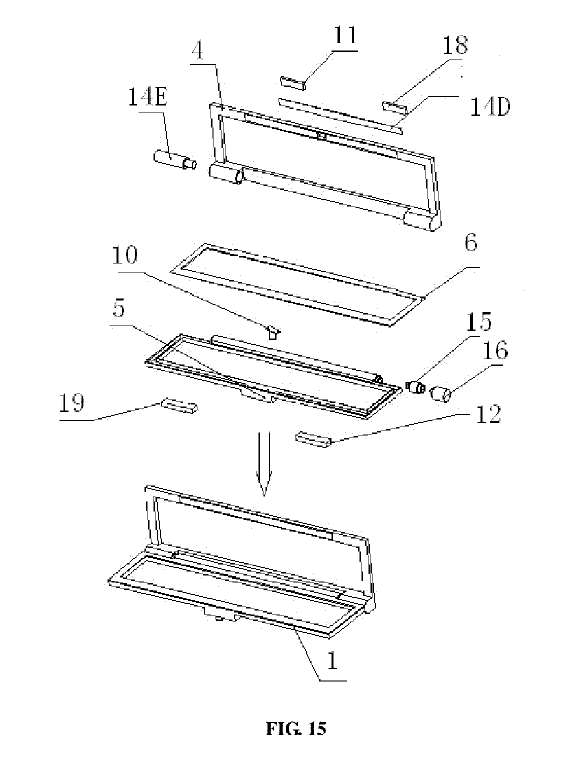

As shown in FIG. 15, the license plate frame single-axis rotatable shooting device 1 further includes a first natural magnet 11, a second natural magnet 18 and a small cover plate 14D that are fixedly connected to the top border of the license plate frame. The small cover plate 14D is configured for encapsulating both the first natural magnet 11 and the second natural magnet 18 in the top border of the license plate frame 4.

The license plate frame single-axis rotatable shooting device 1 further includes a large cover plate 6 and a rotary support 5 in shape same as that of the license plate frame. The top edge of the rotary support 5 is rotationally connected with the bottom border of the license plate frame 4, and the bottom edge of the rotary support 5 rotates about the bottom border of the license plate frame 4. The top edge of the rotary support 5 is provided thereon with a rotary shaft 51. The rotary shaft 51 is sequentially connected with a gear box 15 and a motor 16. Moreover, the motor 16 is rotationally connected with the gear box 15, and the gear box 15 is in key connection with the rotary shaft 51 on the rotary support 5. The bottom edge of the rotary support 5 is provided therein with a third natural magnet 19, an electronic magnet 12 and the first camera 10. The large cover plate is configured for sealing the third natural magnet, the electronic magnet and the first camera in the rotary support.

After the rotary support 5 rotates with respect to the license plate frame 4 to be in a closed state, the first natural magnet 11 at the top border of the license plate frame 4 and the third natural magnet 19 of the rotary support 5 are opposite to each other in position, and opposite in magnetic polarity. After the rotary support 5 rotates with respect to the license plate frame 4 to be in an opened state, the second natural magnet 18 at the top border of the license plate frame 4 and the electronic magnet 12 of the rotary support 5 are opposite to each other in position, and have the same magnetic polarity.

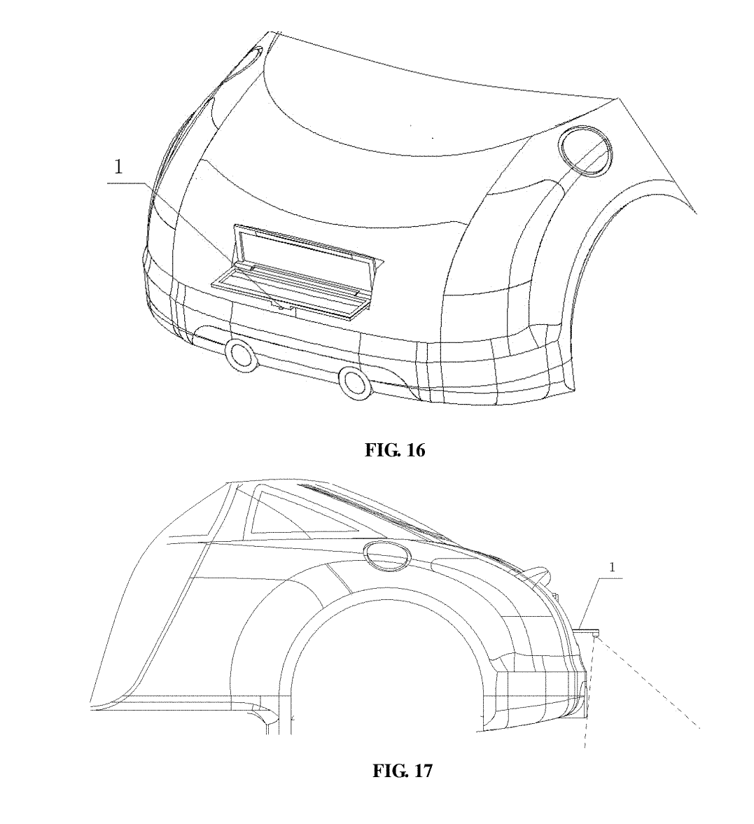

It should be noted that it can be known by analyzing the specific structure of above Embodiment 5: First, as to the core structure, the rotary support are rotatable relative to the license plate frame, wherein the top edge of the rotary support is provided thereon with a rotary shaft as a rotation shaft, actually, the rotary support likewise rotates about one border of the license plate frame (i.e., rotating about the bottom border of the license plate frame). The rotation angle of the rotary shaft is changed through driving by means of the motor and the gear box. After the motor finally drives the rotary shaft to rotate by a certain angle, the first camera in the bottom edge of the rotary support can be separated from the original spatial position of the license plate frame, so as to realize protrusion and retraction through rotation, enabling the first camera to shoot the scenes at the rear bottom of the vehicle (i.e., shooting the scenes at two sides of the vehicle body and in the vicinity of the rear tires). At the same time, the magnetic devices on the abovementioned rotary support and the license plate frame can help to realize the separation and attachment through rotation. As to the non-core structures (e.g., the small cover plate, the large cover plate, a reel), no further description is made herein. As to the corresponding mode of rotation about the bottom border of the license plate frame, reference can mainly be made to FIG. 15, FIG. 16 and FIG. 17.

Specifically, in Embodiment 1, Embodiment 2 and Embodiment 3, the first camera is fixedly connected to the bottom of the rotary handle. The lens of the first camera is arranged to face downward.

In addition, specifically in Embodiment 4 and Embodiment 5, the first camera is fixedly connected to the bottom edge of the rotary support. The lens of the first camera is arranged to be face downward.

The vehicle roof triangular connection rod rotatable shooting device provided in Embodiment 1 can also have a variety of structural forms, and only two embodiments are provided in the present application (specifically referring to Embodiment 6 and Embodiment 7). These two structural forms can be matched with different types of vehicles, which will be respectively described below.

### Embodiment 6

As to the basic structure provided in embodiment 1, comprised in the vehicle roof triangular connection rod rotatable shooting device provided in Embodiment 6, no further description is made herein.

As shown in FIG. 18, the vehicle roof triangular connection rod rotatable shooting device 2 further includes a fixing bracket 21 (specifically, the fixing bracket can be fixed on a roof rack on the top of the vehicle) and two shaft sleeves 22 provided at the two ends of the fixing bracket 21 in the front-rear direction of the vehicle.

The vehicle roof triangular connection rod rotatable shooting device 2 further includes a screw rod 23 outside which the two shaft sleeves 22 are sleeved in the front-rear direction of the vehicle, a shooting rod 24 hinged to one of the shaft sleeves, and a connection rod 25 arranged between the shooting rod 24 and the screw rod 23. The screw rod 23, the shooting rod 24 and the connection rod 25 define a triangular shape; specifically, one end of the connection rod 25 is hinged to the shooting rod 24, and the other end of the connection rod 25 and the screw rod 23 form a screw motion pair. The end of the shooting rod 24, away from the hinged portion, is further fixedly connected with a housing 26. The housing 26 is provided with the second cameras 20 in four directions facing forward, backward, leftward and rightward, respectively, and the housing 26 is also provided therein with a ranging radar 17; , the top surface of the housing is also provided with a cover plate 27. One end of the screw rod is further sequentially connected with a gear box 15 and a motor 16; and the motor 16 is rotationally connected with the gear box 15, and the gear box 15 is in key connection with the screw rod 23.

It should be noted that the screw rod, the shooting rod and the connection rod define the triangular shape; and the second cameras in the four directions can take clear images of the scenes in front of the vehicle, behind the vehicle, on the left side of the vehicle and on the right side of the vehicle, and then transmit the images to the display for the driver's reference during reversing. Specifically, the connection rod and the screw rod form the screw motion pair; the motor and the gear box can act as driving structures to drive the screw rod to rotate. After the screw rod rotates, one end of the connection rod will reciprocate along the screw rod, so as to further realize protrusion and retraction (changing the shooting angle and the shooting position), thereby helping the second cameras to shoot the scenes in front of the vehicle, behind the vehicle, on the left side of the vehicle and on the right side of the vehicle. In addition, the structures such as a cover plate, a reel, a bearing and a moving bracket are also included, and no further description is made on them in the embodiments of the present application.

The screw pair herein refers to a mechanical combination realizing the connection effect by using thread engagement. The screw pair generally includes motion pairs formed, for example, by a lead screw and a nut, a screw jack, etc.

### Embodiment 7

As to the basic structure provided in Embodiment 1, comprised in the vehicle roof triangular connection rod rotatable shooting device provided in embodiment 7, no further description is made herein.

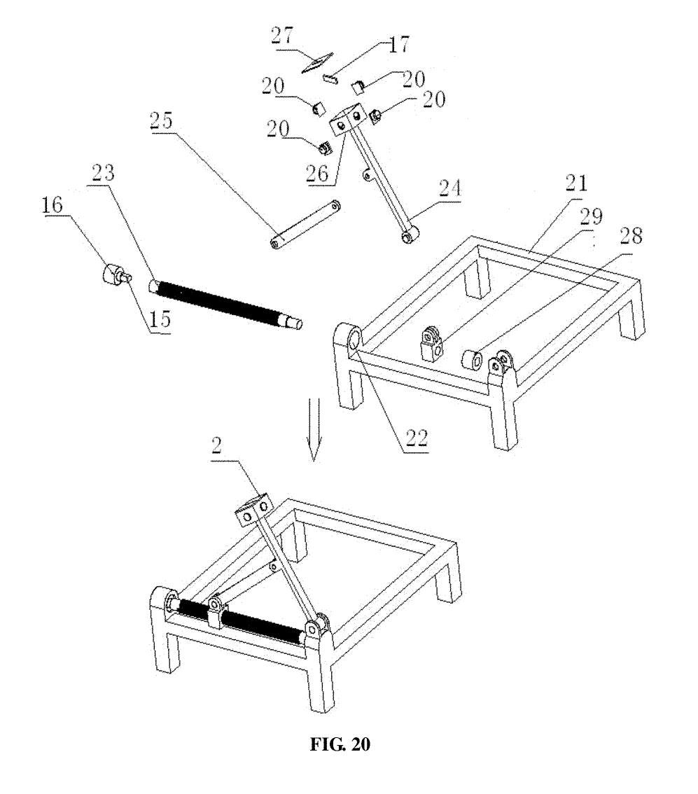

As shown in FIG. 20, the vehicle roof triangular connection rod rotatable shooting device 2 further includes a fixing bracket 21 and two shaft sleeves 22 provided at the two ends of the fixing bracket 21 in the left-right direction of the vehicle.

The vehicle roof triangular connection rod rotatable shooting device 2 further includes a screw rod 23 outside which the two shaft sleeves are sleeved in the left-right direction of the vehicle, a shooting rod 24 hinged to one of the shaft sleeves 22, and a connection rod 25 arranged between the shooting rod 24 and the screw rod 23. The screw rod 23, the shooting rod 24 and the connection rod 25 define a triangular shape; one end of the connection rod 25 is hinged to the shooting rod 24, and the other end of the connection rod 25 and the screw rod 23 form a screw motion pair. The end of the shooting rod 24, away from the hinged portion, is further fixedly connected with a housing 26. The housing 26 is provided with the second cameras 20 in four directions facing forward, backward, leftward and rightward, respectively, and the housing 26 is also provided therein with a ranging radar 17, furthermore, the top surface of the housing 26 is also provided with a cover plate 27. One end of the screw rod 23 is further sequentially connected with a gear box 15 and a motor 16; and the motor 16 is rotationally connected with the gear box 15, and the gear box 15 is in key connection with the screw rod 23.

It should be noted that the screw rod, the shooting rod and the connection rod define the triangular shape; and the second cameras in the four directions can take clear images of the scenes in front of the vehicle, behind the vehicle, on the left side of the vehicle and on the right side of the vehicle, and then transmit the images to the display for the driver's reference during reversing. Specifically, the connection rod and the screw rod form the screw motion pair; the motor and the gear box can act as driving structures to drive the screw rod to rotate. After the screw rod rotates, one end of the connection rod will reciprocate along the screw rod, so as to further realize protrusion and retraction (changing the shooting angle and the shooting position), thereby helping the second cameras to shoot the scenes in front of the vehicle, behind the vehicle, on the left side of the vehicle and on the right side of the vehicle. In addition, the structures such as a cover plate (not shown), a reel (not shown), a bearing 28 and a moving bracket 29 are also included, and no further description is made on them in the embodiments of the present application.

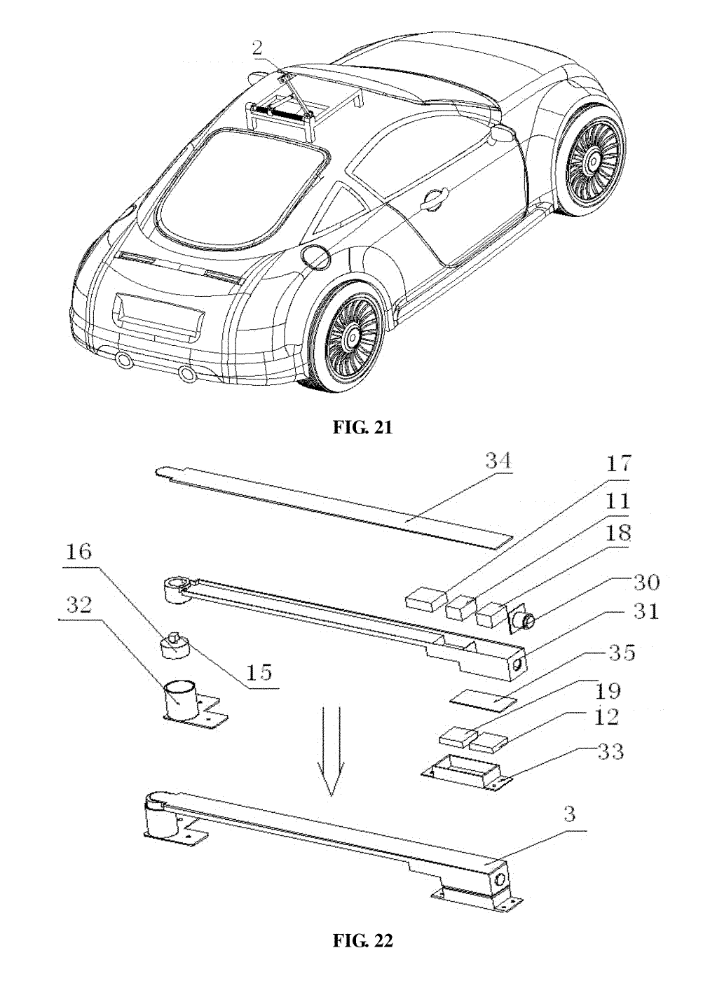

In conclusion, the vehicle roof triangular connection rod rotatable shooting device is generally installed on the top of a vehicle, and mainly includes the cover plate, four second cameras 20, the ranging radar, the shooting rod, the reel, the bearing, the fixing bracket, the connection rod, the screw rod, the reel, the moving bracket, the gear box, the motor etc. The working principle thereof also comprises driving a connection rod mechanism to move through the gear box and the motor, so as to control the movement of the shooting rod. As four cameras are installed on the shooting rod, it is possible to shoot the scenes in front of the vehicle, behind the vehicle, on the left side of the vehicle and on the right side of the vehicle. An example refers to the structure provided in Embodiment 6, as shown in FIG. 18 and FIG. 19. There is another mode for movement of the vehicle roof triangular connection rod rotatable shooting device (for example, the structure provided in Embodiment 7, as shown in FIG. 20 and FIG. 21), i.e., a vehicle roof fixing bracket side edge triangle movement mode.

### Embodiment 8

As to the basic structure provided in embodiment 1, comprised in the vehicle roof single-axis rotatable shooting device provided in embodiment 8, no further description is made herein.

As shown in FIG. 22, the vehicle roof single-axis rotatable shooting device 3 further includes a motor support 32 and a magnet box 33 that are arranged at the two ends respectively. The motor support 32 is configured for being fixedly connected with a motor 16 and a gear box 15, the motor 16 is rotationally connected with the gear box 15, and the gear box 15 is in key connection with the rotary handle 31. The magnet box 33 is provided therein with a third natural magnet 19 and an electronic magnet 12.

The vehicle roof single-axis rotatable shooting device further includes a rotary handle 31 which pivots about the motor support 32. One end of the rotary handle 31 is sequentially connected with the gear box 15 and the motor 16, and the other end of the rotary handle 31 is provided with a third camera 30, a ranging radar 17, a first natural magnet 11 and a second natural magnet 18. The upper and lower sides of the rotary handle are further provided with a cover plate 34 and a small cover plate 35 for sealing the ranging radar, the first natural magnet 11 and the second natural magnet 18.

After the rotary handle 31 rotates to close the magnet box 33, the third natural magnet 19 in the magnet box 33 and the first natural magnet 11 of the rotary handle 31 are opposite to each other in position, and opposite in magnetic polarity. After the rotary handle 31 rotates to open the magnet box 33, the electronic magnet 12 in the magnet box 33 and the second natural magnet 18 of the rotary handle 31 are opposite to each other in position, and have the same magnetic polarity.

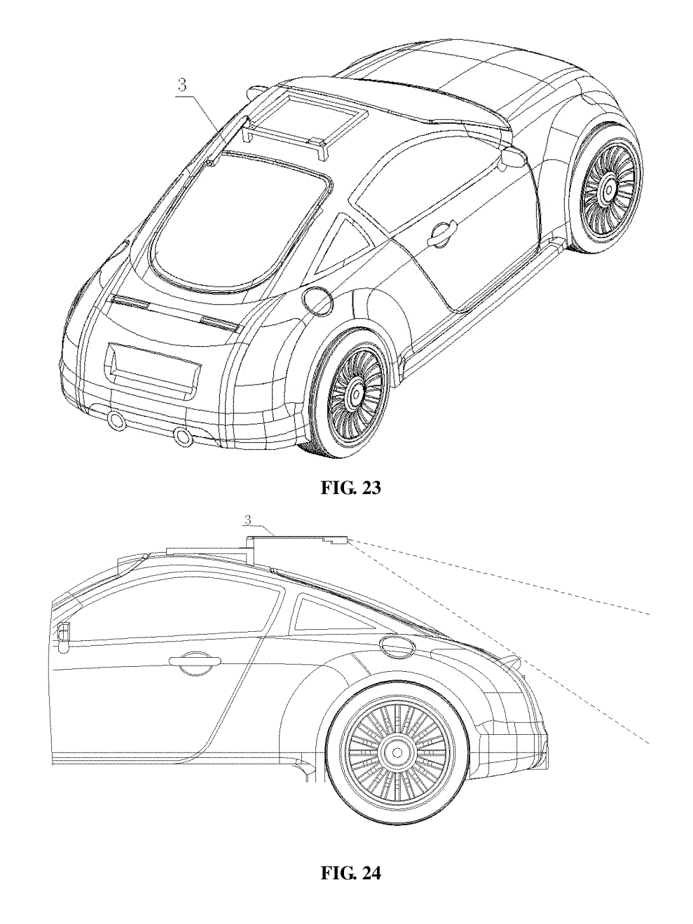

It should be noted that it can be known by analyzing the above core structure: the rotary handle can act as a main rotation structure and can rotate about the motor support as the rotation shaft. That is to say, after the vehicle starts to reverse, the third camera is driven to rotate and move along a circular path, with the length of the rotary handle as the radius (thereby achieving a change in the shooting angle and the shooting position). Specifically, the circular path of the rotary handle covers the front side, the rear side, the left side and the right side of the vehicle, such that omnibearing shooting of the scenes in front of the vehicle, behind the vehicle, on the left side of the vehicle and on the right side of the vehicle can be achieved by the third camera. Moreover, as the third camera may touch an object behind the vehicle after protruding out of the vehicle, therefore, the ranging radar is installed. The ranging radar (the installation position of the ranging radar is close to that of the third camera) can help the driver to identify the distance from the third camera to the object, so as to help the driver to drive backward. Specifically, for example, an alarm can be triggered when the ranging radar is too close to an object. In addition, as to the non-core structural components (for example, the structural components such as the cover plates, etc.) in the embodiment of the present application, no further description is made herein. As to the above specific structures and the movement state thereof, reference can be made to FIG. 22, FIG. 23 and FIG. 24.

In conclusion, for the vehicle interior rearview mirror system with cameras provided in the embodiments of the present application, during reversing, the respective reversing cameras (for example, the first camera, the second cameras and the third camera) are not in a fixed structure mode, and do not have fixed shooting angle and shooting position, actually, the cameras have a structure with changing shooting angles and shooting positions, which causes them not only can shoot the scenes on the two sides of the vehicle body and in the vicinity of the rear tires, but also can shoot the scenes in front of the vehicle, behind the vehicle, on the left side of the vehicle and on the right side of the vehicle; and the rotation angle thereof is also change.

Furthermore, the vehicle interior rearview mirror system with cameras provided in the embodiments of the present application is no longer constrained by the spatial position of the license plate frame, or by the unchanged shooting angle and shooting position. Instead, the shooting position and the shooting angle are adjustable, some of the structures can be adjusted by rotation by 360 degrees, some can achieve front-back and left-right translational protrusion and retraction. Therefore, the cameras can be adjusted to an optimal angle so as to obtain omnibearing images of the vehicle (expanding the shooting scope of the cameras). Thus, the vehicle interior rearview mirror system with cameras provided in the embodiments of the present application has a panoramic shooting function and cannot generate shooting blind angles, which avoids car accidents caused by misjudgment of the driver resulting from shot images with shooting blind angles. Moreover, the system has a variety of installation structures, and the installation mode and the installation structure are flexible and varied (i.e., installed on a license plate frame and a roof rack, perfectly accomplishing the installation of the cameras), which can be adapted to different types of vehicles.

Finally, it should be noted that the above embodiments are only used to illustrate the technical solutions of the present application, but not limit thereto. Although the present application has been described in detail with reference to the foregoing embodiments, it should be understood by a person skilled in the art that modification can still be made to the technical solutions described in the foregoing embodiments, or equivalent substitution can be made to some or all of the technical features therein. These modification or substitution would not cause the essence of the corresponding technical solutions to depart from the scope of the technical solutions of the embodiments of the present application.

1. A vehicle interior rearview mirror system with cameras, comprising:
a license plate frame single-axis rotatable shooting device provided on a license plate frame at a rear of a vehicle, and a vehicle roof triangular connection rod rotatable shooting device or a vehicle roof single-axis rotatable shooting device provided on a top of the vehicle, with the license plate frame single-axis rotatable shooting device, the vehicle roof triangular connection rod rotatable shooting device and the vehicle roof single-axis rotatable shooting device being configured for driving the cameras to protrude out from the license plate frame or a roof rack to a position at a certain distance from the vehicle for shooting,
wherein the license plate frame single-axis rotatable shooting device comprises a first camera, and the license plate frame single-axis rotatable shooting device is configured for rotating about one border of the license plate frame with the border as a rotation shaft, after the vehicle starts to reverse, so as to drive the first camera to turn and protrude out from a spatial position of the license plate frame;
the vehicle roof triangular connection rod rotatable shooting device comprises four second cameras facing forward, backward, leftward and rightward, respectively, and the vehicle roof triangular connection rod rotatable shooting device is configured for driving the four second cameras to horizontally move simultaneously in a front-rear direction or a left-right direction of the vehicle, after the vehicle starts to reverse; and
the vehicle roof single-axis rotatable shooting device comprises a third camera and a rotary handle, the third camera is provided at one end of the rotary handle, the vehicle roof single-axis rotatable shooting device is configured for driving the rotary handle to rotate and driving the third camera to move along a circular path, with a length of the rotary handle as a radius, after the vehicle starts to reverse; and the circular path of the rotary handle passes through a front side, a rear side, a left side and a right side of the vehicle, and the first camera, the second cameras and the third camera are each in communication with a display on a center console of the vehicle.

2. The vehicle interior rearview mirror system with cameras according to claim 1,
wherein the license plate frame single-axis rotatable shooting device further comprises a first natural magnet and an electronic magnet that are fixedly connected to a top border of the license plate frame;
the license plate frame single-axis rotatable shooting device further comprises a rotary handle configured to rotate in a plane where the top border of the license plate frame is located, with the rotary handle rotating about a left border of the license plate frame, one end of the rotary handle is rotationally connected with the top border of the license plate frame and is sequentially connected with a gear box and a motor, and other end of the rotary handle is provided with the first camera, an inner layer of the rotary handle is further provided with a ranging radar, a second natural magnet and a third natural magnet, the motor is rotationally connected with the gear box, and the gear box is in key connection with the rotary handle; and
after the rotary handle rotates with respect to the license plate frame to be in a closed state, the first natural magnet at the top border of the license plate frame and the second natural magnet of the rotary handle are opposite to each other in position, and opposite in magnetic polarity; and after the rotary handle rotates with respect to the license plate frame to be in an opened state, the electronic magnet at the top border of the license plate frame and the third natural magnet of the rotary handle are opposite to each other in position, and have same magnetic polarity.

3. The vehicle interior rearview mirror system with cameras according to claim 1,
wherein the license plate frame single-axis rotatable shooting device further comprises a first natural magnet and an electronic magnet that are fixedly connected to a bottom border of the license plate frame;
the license plate frame single-axis rotatable shooting device further comprises a rotary handle configured to rotate in a plane where the bottom border of the license plate frame is located, with the rotary handle rotating about a left border of the license plate frame, one end of the rotary handle is rotationally connected with the bottom border of the license plate frame and is sequentially connected with a gear box and a motor, and other end of the rotary handle is provided with the first camera, an inner layer of the rotary handle is further provided with a ranging radar, a second natural magnet and a third natural magnet, the motor is rotationally connected with the gear box, and the gear box is in key connection with the rotary handle; and
after the rotary handle rotates with respect to the license plate frame to be in a closed state, the first natural magnet at the bottom border of the license plate frame and the second natural magnet of the rotary handle are opposite to each other in position, and opposite in magnetic polarity, and after the rotary handle rotates with respect to the license plate frame to be in an opened state, the electronic magnet at the bottom border of the license plate frame and the third natural magnet of the rotary handle are opposite to each other in position, and have same magnetic polarity.

4. The vehicle interior rearview mirror system with cameras according to claim 1,
wherein the license plate frame single-axis rotatable shooting device further comprises a first natural magnet and a second natural magnet that are fixedly connected to a bottom border of the license plate frame;
the license plate frame single-axis rotatable shooting device further comprises a rotary support in shape same as that of the license plate frame, a top edge of the rotary support is rotationally connected with a top border of the license plate frame, the top edge of the rotary support is configured to rotate about the top border of the license plate frame, the top edge of the rotary support is provided thereon with a rotary shaft, the rotary shaft is sequentially connected with a gear box and a motor, the motor is rotationally connected with the gear box, the gear box is in key connection with the rotary shaft on the rotary support, and a bottom edge of the rotary support is provided therein with a third natural magnet, an electronic magnet and the first camera; and
after the rotary support rotates with respect to the license plate frame to be in a closed state, the first natural magnet at the bottom border of the license plate frame and the third natural magnet of the rotary support are opposite to each other in position, and opposite in magnetic polarity; and after the rotary support rotates with respect to the license plate frame to be in an opened state, the second natural magnet at the bottom border of the license plate frame and the electronic magnet of the rotary support are opposite to each other in position, and have same magnetic polarity.

5. The vehicle interior rearview mirror system with cameras according to claim 1,
wherein the license plate frame single-axis rotatable shooting device further comprises a first natural magnet and a second natural magnet that are fixedly connected to a top border of the license plate frame;
the license plate frame single-axis rotatable shooting device further comprises a rotary support in shape same as that of the license plate frame; a bottom edge of the rotary support is rotationally connected with a bottom border of the license plate frame, the bottom edge of the rotary support is configured to rotate about the bottom border of the license plate frame, a top edge of the rotary support is provided thereon with a rotary shaft, the rotary shaft is sequentially connected with a gear box and a motor, the motor is rotationally connected with the gear box, the gear box is in key connection with the rotary shaft on the rotary support, and the bottom edge of the rotary support is provided therein with a third natural magnet, an electronic magnet and the first camera; and
after the rotary support rotates with respect to the license plate frame to be in closed state, the first natural magnet at the top border of the license plate frame and the third natural magnet of the rotary support are opposite to each other in position, and opposite in magnetic polarity, and after the rotary support rotates with respect to the license plate frame to be in an opened state, the second natural magnet at the top border of the license plate frame and the electronic magnet of the rotary support are opposite to each other in position, and have same magnetic polarity.

6. The vehicle interior rearview mirror system with cameras according to claim 2,
wherein the first camera is fixedly connected to a bottom of the rotary handle, and a lens of the first camera is arranged to face downward.

7. The vehicle interior rearview mirror system with cameras according to claim 4,
wherein the first cameras are fixedly connected to a bottom edge of the rotary support, and a lens of the first camera is arranged to face downward.

8. The vehicle interior rearview mirror system with cameras according to claim 1,
wherein the vehicle roof triangular connection rod rotatable shooting device further comprises a fixing bracket and two shaft sleeves provided at two ends of the fixing bracket in the front-rear direction of the vehicle; and
the vehicle roof triangular connection rod rotatable shooting device further comprises a screw rod, outside which the two shaft sleeves are sleeved in the front-rear direction of the vehicle, a shooting rod hinged to one of the shaft sleeves, and a connection rod arranged between the shooting rod and the screw rod; the screw rod, the shooting rod and the connection rod define a triangular shape; one end of the connection rod is hinged to the shooting rod, and the screw rod and other end of the connection rod form a screw motion pair; an end of the shooting rod, away from the hinged portion, is further fixedly connected with a housing; the housing is provided with the second cameras in four directions facing forward, backward, leftward and rightward, respectively, and the housing is also provided therein with a ranging radar; one end of the screw rod is further sequentially connected with a gear box and a motor; and the motor is rotationally connected with the gear box, and the gear box is in key connection with the screw rod.

9. The vehicle interior rearview mirror system with cameras according to claim 1,
wherein the vehicle roof triangular connection rod rotatable shooting device further comprises a fixing bracket and two shaft sleeves provided at two ends of the fixing bracket in the left-right direction of the vehicle; and
the vehicle roof triangular connection rod rotatable shooting device further comprises a screw rod, outside which the two shaft sleeves are sleeved in the left-right direction of the vehicle, a shooting rod hinged to one of the shaft sleeves, and a connection rod arranged between the shooting rod and the screw rod; the screw rod, the shooting rod and the connection rod define a triangular shape; one end of the connection rod is hinged to the shooting rod, and the screw rod and other end of the connection rod form a screw motion pair; an end of the shooting rod, away from the hinged portion, is further fixedly connected with a housing; the housing is provided with the second cameras in four directions facing forward, backward, leftward and rightward, respectively, and the housing is also provided therein with a ranging radar; one end of the screw rod is further sequentially connected with a gear box and a motor; and the motor is rotationally connected with the gear box, and the gear box is in key connection with the screw rod.

10. The vehicle interior rearview mirror system with cameras according to claim 1,
wherein the vehicle roof single-axis rotatable shooting device further comprises a motor support and a magnet box that are arranged at two ends respectively; the motor support is configured for being fixedly connected with a motor and a gear box, the motor is rotationally connected with the gear box, and the gear box is in key connection with the rotary handle; and the magnet box is provided therein with a third natural magnet and an electronic magnet;
the vehicle roof single-axis rotatable shooting device further comprises a rotary handle configured to pivot about the motor support; one end of the rotary handle is sequentially connected with the gear box and the motor, and other end of the rotary handle is further provided with the third camera, a ranging radar, a first natural magnet and a second natural magnet; and
after the rotary handle rotates to close the magnet box, the third natural magnet in the magnet box and the first natural magnet of the rotary handle are opposite to each other in position, and opposite in magnetic polarity; and after the rotary handle rotates to open the magnet box, the electronic magnet in the magnet box and the second natural magnet of the rotary handle are opposite to each other in position, and have same magnetic polarity

11. The vehicle interior rearview mirror system with cameras according to claim 3,
wherein the first camera is fixedly connected to a bottom of the rotary handle, and a lens of the first camera is arranged to face downward.

12. The vehicle interior rearview mirror system with cameras according to claim 5,
wherein the first cameras are fixedly connected to a bottom edge of the rotary support, and a lens of the first camera is arranged to face downward.
